(19) United States
(12) Patent Application Publication
(10) Pub. No.: US 2010/0313567 A1
(43) Pub. Date: Dec. 16, 2010

(54) GAS TURBINE

(75) Inventors: Sosuke Nakamura, Hyogo-ken (JP); Keisuke Matsuyama, Hyogo-ken (JP); Takashi Hiyama, Hyogo-ken (JP); Yasuro Sakamoto, Hyogo-ken (JP); Kaoru Sakata, Hyogo-ken (JP)

Correspondence Address: LOWE HAUPTMAN HAM & BERNER, LLP, 1700 DIAGONAL ROAD, SUITE 300, ALEXANDRIA, VA, 22314, US

(73) Assignee: MITSUBISHI HEAVY INDUSTRIES, LTD., Tokyo (JP)

(21) Appl. No.: 12/866,419

(22) PCT Filed: Nov. 20, 2008
(86) PCT No.: PCT/JP2008/071130

§ 371 Date: Aug. 5, 2010

(30) Foreign Application Priority Data
Feb. 20, 2008 (JP) 2008-038896

(51) Int. Cl. F02C 3/00

(52) U.S. Cl. 60/722

(57) ABSTRACT

In a gas turbine that generates rotational power by supplying fuel to compressed air compressed by a compressor and burning the fuel in a combustor and supplying resultant combustion gas to a turbine, a circumferential distance starting from a leading edge of a turbine first stage nozzle toward a trailing edge side of the first stage nozzle and ending at center of transition pieces of such combustors that are adjacent in a circumferential direction is set relative to a circumferential pitch of such first stage nozzles within a range of 0.05≦S/P≦0.15, and an axial distance between a leading edge of the first stage nozzle and a transition piece rear end of the combustor is set relative to the circumferential pitch of the first stage nozzles within a range of 0.00≦L/P≦0.13. By improving the relative position of a transition piece of the combustor and the first stage nozzle, both suppression of inner pressure fluctuations of the combustor and enhancement in aerodynamic efficiency can be achieved.

### TECHNICAL FIELD

The present invention relates to a gas turbine, and more particularly, to a gas turbine with an improved relative position of a combustor transition piece and a turbine first stage nozzle.

### BACKGROUND ART

A gas turbine includes a compressor, a combustor, and a turbine. The compressor compresses air taken in through an air inlet to make high-temperature, high-pressure compressed air. The combustor supplies fuel to the compressed air and burns the fuel to make high-temperature, high-pressure combustion gas. The turbine is configured to include a plurality of turbine nozzles and turbine rotor blades alternately arranged in a casing. The turbine rotor blades are driven by the combustion gas supplied to an exhaust passage, whereby a rotor connected to a generator is driven to rotate, for example. The combustion gas that has driven the turbine has its pressure converted into static pressure by a diffuser, and is then released into the atmosphere.

Some conventional gas turbines have a carefully devised relative position of a transition piece of the combustor that is an outlet through which the combustion gas is guided toward the turbine and a turbine first stage nozzle that is exposed to the combustion gas first. Such gas turbines are designed to include two (even-numbered multiple) turbine first stage nozzles per combustor, and are so configured that the center of the transition piece of the combustor coincides with the inter-nozzle center at the leading edges of the first stage nozzles. The combustion gas from the combustor is made to pass mainly between the first stage nozzles, thereby lowering the maximum temperature on the surface of the first stage nozzles (see Patent Document 1, for example).

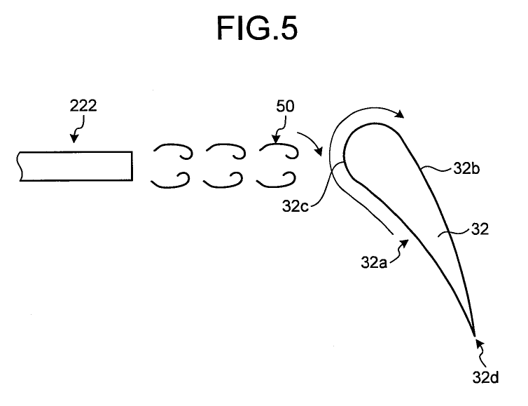

A method is known that enhances turbine efficiency by controlling the relative positional relationship of the transition piece of the combustor and the turbine first stage nozzles (see Patent Document 2, for example). As illustrated in FIG. 5, a wake flow (Karman vortex street) 50 developed after a transition piece rear end 222 of a combustor affects gas flows around each first stage nozzle 32. A method is disclosed that enhances turbine efficiency by making the wake flow 50 developed after the transition piece rear end 222 of the combustor flow into a pressure surface side 32a of the first stage nozzle that is closer to its leading edge 32c. Another method is also disclosed that suppresses the development of wake flows themselves and enhances turbine efficiency by making the distance between the transition piece of the combustor and the first stage nozzle smaller.

[Patent Document 1] Japanese Patent Application Laid-open No. 2005-120871

### [Patent Document 2] Japanese Patent Application Laid-open No. 2006-52910

### DISCLOSURE OF INVENTION

1. Problem to be Solved by the Invention

Depending on the relative position of the combustor and the first stage nozzle, a wake flow (Karman vortex street) developed after the transition piece rear end of the combustor causes edge tones along the leading edge of the turbine first stage nozzle. Resonance of three elements, that is, the frequency of the wake flow, and the frequency and the acoustic eigenvalue of the edge tones, causes inner pressure fluctuations of the combustor, disadvantageously resulting in the occurrence of noise or vibration during its operation. Note that the inner pressure fluctuations mentioned above are distinguishable from inner pressure fluctuations (combustion oscillation) attributable to a combustion state of fuel by their different drive sources. The inner pressure fluctuations that arise from edge tones caused by wake flows are hereinafter simply referred to as the inner pressure fluctuations, unless otherwise specified.

As described above, by placing the transition piece of the combustor and the first stage nozzle closer to each other, the development of wake flows and the inner pressure fluctuations of the combustor caused by the occurrence of edge tones are supposed to be suppressed. However, to enhance turbine efficiency, wake flows need to be flown into the pressure surface side of the first stage nozzle. To this end, the transition piece of the combustor and the first stage nozzle need to be constantly spaced apart by a certain distance, which means suppressing the inner pressure fluctuations and enhancing turbine efficiency are in a trade-off relationship. Patent Document 2 discloses no means to solve them.

The present invention has been made in view of the foregoing, and has an object to provide a gas turbine that can suppress inner pressure fluctuations of a combustor and enhance aerodynamic efficiency.

2. Means for Solving Problem

According to an aspect of the present invention, in a gas turbine that generates rotational power by supplying fuel to compressed air compressed by a compressor and burning the fuel in a combustor and supplying resultant combustion gas to a turbine, a circumferential distance S starting from a leading edge of a turbine first stage nozzle toward a trailing edge side of the first stage nozzle and ending at center of such combustors that are adjacent in a circumferential direction is set relative to a circumferential pitch P of such first stage nozzles within a range of 0.05≦S/P≦0.15, and an axial distance L between a leading edge of the first stage nozzle and a rear end of the combustor is set relative to the circumferential pitch P of the first stage nozzles within a range of 0.00≦L/P≦0.13.

With this gas turbine, the smaller the axial distance L is, the further the development of wake flows after the rear end of the combustor is suppressed. Accordingly, the occurrence of edge tones along the leading edge of the first stage nozzle can be suppressed. In addition, by setting the circumferential distance S relative to the circumferential pitch P within the range of 0.05≦S/P≦0.15, the aerodynamic efficiency of the first stage nozzle can be enhanced in a stable manner.

Advantageously, in the gas turbine, the circumferential distance S is set relative to the circumferential pitch P to satisfy S/P=0.10.

With this gas turbine, the inner pressure fluctuations of the combustor can be further suppressed and the aerodynamic efficiency can be enhanced.

Advantageously, in the gas turbine, the axial distance L is set relative to the circumferential pitch P within a range of 0.08≦L/P≦0.13.

With this gas turbine, even if it is difficult to make the axial distance L relative to the circumferential pitch P satisfy L/P=0, in other words, it is difficult to place the leading edge of the first stage nozzle and the rear end of the combustor closest to each other, the occurrence of edge tones can be suppressed desirably and the inner pressure fluctuations of the combustor can be suppressed.

Advantageously, in the gas turbine, a circumferential thickness D of a rear end of the combustors that are adjacent in the circumferential direction is set relative to the circumferential pitch P within a range of D/P≦0.26.

With this gas turbine thus configured, the occurrence of edge tones can be further suppressed to suppress the inner pressure fluctuations of the combustor, and the aerodynamic efficiency can be enhanced.

### EFFECT OF THE INVENTION

According to the present invention, by making the axial distance L smaller, the development of wake flows after the outlet edge of the combustor transition piece can be suppressed, and the occurrence of edge tones along the leading edge of the turbine first stage nozzle can be thus suppressed. Furthermore, by desirably setting the range of the circumferential distance S, the aerodynamic efficiency of the first stage nozzle can be enhanced in a stable manner.

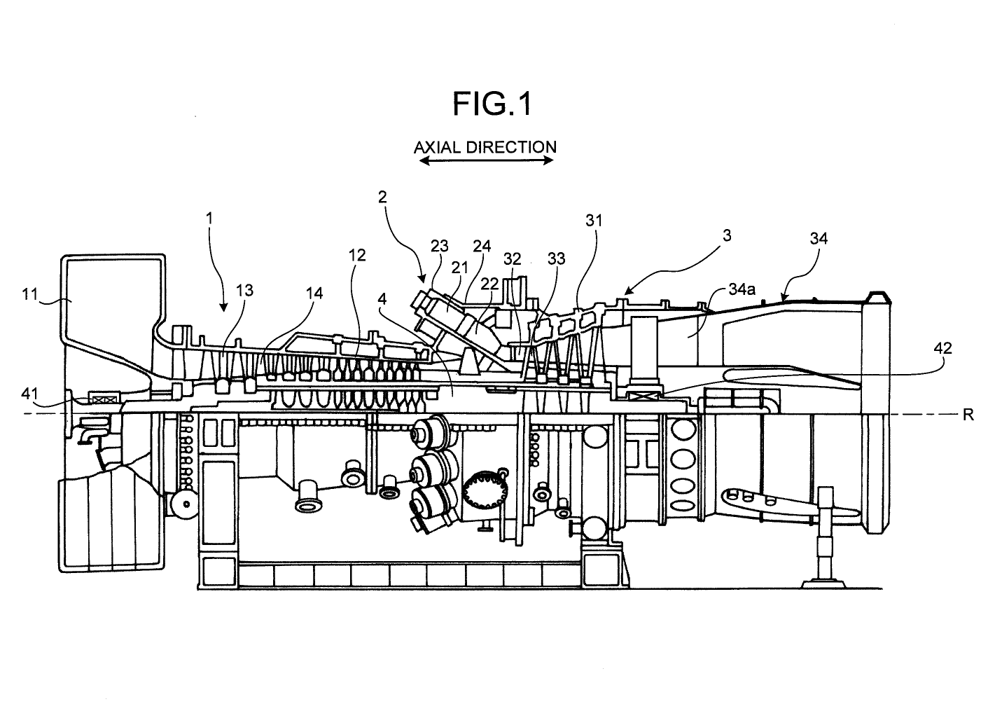

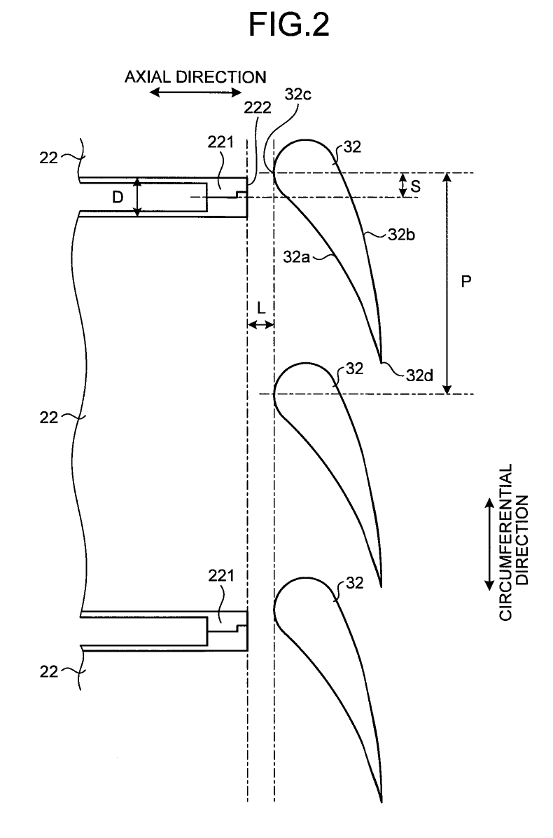

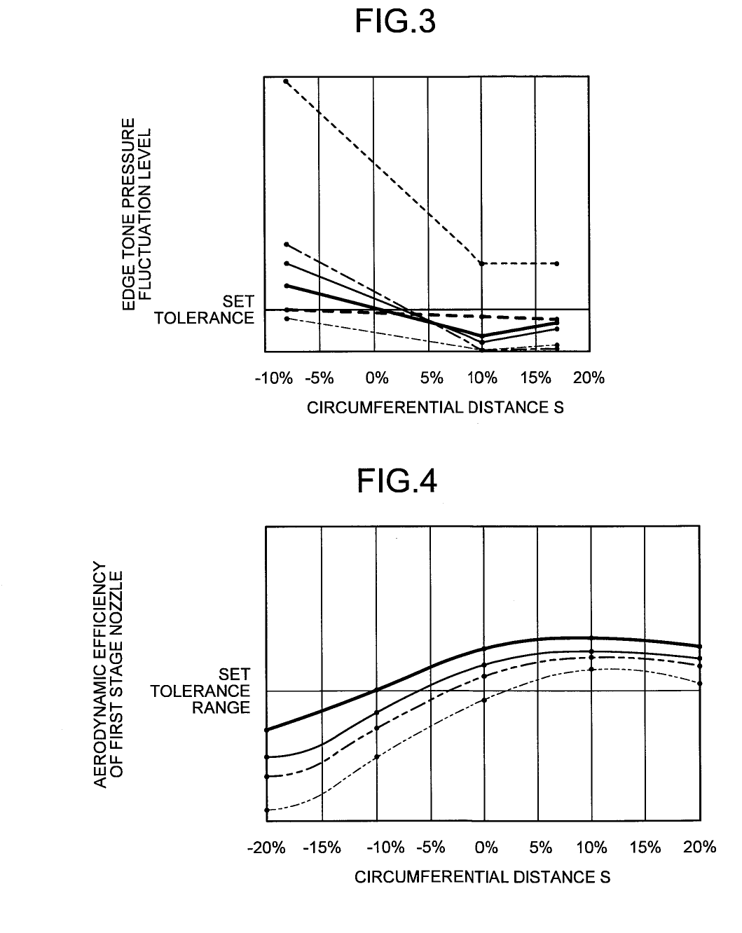

### BRIEF DESCRIPTION OF DRAWINGS

[FIG. 1] FIG. 1 is a schematic configuration diagram of a gas turbine according to an embodiment of the present invention.

[FIG. 2] FIG. 2 is a schematic diagram of the layout of compressor transition pieces and turbine first stage nozzles.

[FIG. 3] FIG. 3 is a chart of edge tone pressure fluctuation levels.

[FIG. 4] FIG. 4 is a chart of the aerodynamic efficiency of the first stage nozzles.

[FIG. 5] FIG. 5 is a schematic diagram of a wake flow developed after a transition piece rear end.

### EXPLANATIONS OF LETTERS OR NUMERALS

1 compressor

11 air inlet

12 compressor casing

13 compressor vane

14 compressor rotor blade

2 combustor

21 inner cylinder

22 transition piece

221 connecting member

222 transition piece rear end

23 outer casing

24 combustor casing

3 turbine

31 turbine casing

32 turbine nozzle

32a turbine nozzle pressure surface

32b turbine nozzle suction surface

32c turbine nozzle leading edge

32d turbine nozzle trailing edge

33 turbine rotor blade

34 exhaust chamber

34a exhaust diffuser

4 rotor

41 bearing

42 bearing

50 wake flow (Karman vortex street)

R axial center

L axial distance

P circumferential pitch

S circumferential distance

D circumferential thickness

### BEST MODE (S) FOR CARRYING OUT THE INVENTION

An exemplary embodiment of a gas turbine according to the present invention will now be described in detail with reference to some accompanying drawings. This embodiment is not intended to limit the present invention.

FIG. 1 is a schematic configuration diagram of a gas turbine according to an embodiment of the present invention. FIG. 2 is a schematic diagram of the layout of compressor transition pieces and turbine first stage nozzles.

The gas turbine includes, as illustrated in FIG. 1, a compressor 1, a combustor 2, and a turbine 3. A rotor 4 is provided to penetrate the center of the compressor 1, the combustor 2, and the turbine 3. The compressor 1, the combustor 2, and the turbine 3 are arranged in this order from the front side to the rear side of airflow along the axial center R of the rotor 4. In the description below, an axial direction means a direction parallel to the axial center R, a circumferential direction means a circumferential direction about the axial center R, and a radial direction means a direction perpendicular to the axial center R.

The compressor 1 compresses air to make compressed air. The compressor 1 includes, in a compressor casing 12 having an air inlet 11 through which air is taken in, a compressor vane 13 and a compressor rotor blade 14. The compressor vane 13 is placed on the compressor casing 12 side, and a plurality of such compressor vanes 13 is provided in the circumferential direction. The compressor rotor blade 14 is placed on the rotor 4 side, and a plurality of such compressor rotor blades 14 is provided in the circumferential direction. The compressor vanes 13 and the compressor rotor blades 14 are arranged alternately along the axial direction.

The combustor 2 supplies fuel to the compressed air compressed by the compressor 1 and ignites the fuel with a burner to make high-temperature, high-pressure combustion gas. The combustor 2 includes an inner cylinder 21 as a combustion cylinder having the burner (not illustrated) and mixing therein the compressed air and the fuel to burn the fuel, a transition piece 22 that guides the combustion gas from the inner cylinder 21 to the turbine 3, and an outer casing 23 that guides the compressed air from the compressor 1 to the inner cylinder 21. A plurality of such combustors 2 is provided in the circumferential direction with respect to a combustor casing 24.

The turbine 3 generates rotational power from the combustion gas combusted by the combustor 2. The turbine 3 includes, in a turbine casing 31, a turbine nozzle 32 and a turbine rotor blade 33. The turbine nozzle 32 is placed on the turbine casing 31 side, and a plurality of such turbine nozzles 32 is provided in the circumferential direction. The turbine rotor blade 33 is placed on the rotor 4 side, and a plurality of such turbine rotor blades 33 is provided in the circumferential direction. The turbine nozzles 32 and the turbine rotor blades 33 are arranged alternately along the axial direction. On the rear side of the turbine casing 31, an exhaust chamber 34 including an exhaust diffuser 34a that communicates with the turbine 3 is provided.

The rotor 4 has one end on the compressor 1 side supported by a bearing 41 and the other end on the exhaust chamber 34 side supported by a bearing 42, and is provided rotatably about the axial center R. The end of the rotor 4 on the exhaust chamber 34 side is connected to a drive shaft of a generator (not illustrated).

In the gas turbine thus configured, the air taken in through the air inlet 11 of the compressor 1 is compressed while passing through the compressor vanes 13 and the compressor rotor blades 14 and turned into high-temperature, high-pressure compressed air. Then, the combustor 2 supplies certain fuel to the compressed air and burns the fuel, whereby high-temperature, high-pressure combustion gas is generated. The combustion gas passes through the turbine nozzles 32 and the turbine rotor blades 33 of the turbine 3, thereby driving the rotor 4 to rotate. By applying rotational power to the generator connected to the rotor 4, electric power is generated. Exhaust gas after driving the rotor 4 to rotate has its pressure converted into static pressure by the exhaust diffuser 34a in the exhaust chamber 34, and is then released into the atmosphere.

In the gas turbine thus configured, the transition piece 22 of the combustor 2 and a turbine first stage nozzle 32 of the turbine 3 that is placed closest to the combustor 2 are placed in the following relationship.

As illustrated in FIG. 2, in the combustors 2 that are adjacent in the circumferential direction, the rear ends of the transition pieces 22 on their respective rear ends are connected to each other by a connecting member 221. Each first stage nozzle 32 is so arranged that its leading edge 32c is directed forwardly, i.e., toward the combustor 2 side, and its trailing edge 32d is directed backwardly and obliquely to the rotational direction (circumferential direction) of the rotor 4. This configuration includes two first stage nozzles 32 per combustor 2.

A circumferential distance S starting from the leading edge 32c (the closest part to the combustor 2 side) of the first stage nozzle 32 toward the trailing edge 32d side of the first stage nozzle 32 and ending at the center of the combustors 2 (the connected transition pieces 22) is set relative to a circumferential pitch P of the first stage nozzles 32 within the range of 0.05≦S/P≦0.15. In other words, the circumferential distance S is set within the range of equal to or more than 5% and equal to or less than 15% of the circumferential pitch P.

An axial distance L between the leading edge 32c of the first stage nozzle 32 and the transition piece rear end 222 is set relative to the circumferential pitch P of the first stage nozzles 32 within the range of 0.00≦L/P≦0.13. In other words, the axial distance L is set within the range of equal to or more than 0% and equal to or less than 13% of the circumferential pitch P.

A circumferential thickness D of an end of the connected transition pieces 22 of the combustors 2 that are adjacent in the circumferential direction is set relative to the circumferential pitch P within the range of D/P≦0.26.

In other words, the circumferential thickness D is set within the range of equal to or less than 26% of the circumferential pitch P.

Analysis results of the present embodiment in which the combustors 2 and the first stage nozzles 32 are placed to satisfy the relationships described above and of comparative examples are plotted in FIGS. 3 and 4. FIG. 3 is a chart of edge tone pressure fluctuation levels. FIG. 4 is a chart of the aerodynamic efficiency of the first stage nozzles.

Referring to FIG. 3, the circumferential distance S was set within the range of equal to or more than −8% and equal to or less than 17%. The analysis was conducted with four cases as embodiments and two cases each as comparative examples with different axial distances L and circumferential thicknesses D. The rate of the axial distance L to the circumferential pitch P is represented by L/P, and the rate of the circumferential thickness D to the pitch P is represented by D/P. Embodiment 1 satisfies L/P=0.13 and D/P=0.19, and is indicated by the thick solid line. Embodiment 2 satisfies L/P=0.13 and D/P=0.26, and is indicated by the thin solid line. Embodiment 3 satisfies L/P=0.08 and D/P=0.19, and is indicated by the thick dashed-dotted line. Embodiment 4 satisfies L/P=0.08 and D/P=0.26, and is indicated by the thin dashed-dotted line. Comparative Example 1 satisfies L/P=0.42 and D/P=0.19, and is indicated by the thick broken line. Comparative Example 2 satisfies L/P=0.42 and D/P=0.26, and is indicated by the thin broken line. The negative sign of the circumferential distance S indicates a circumferential distance starting from the leading edge 32c (the closest part to the combustor 2 side) of the first stage nozzle 32 toward the opposite side (on the leading edge 32c side) to the trailing edge 32d side of the first stage nozzle 32.

Referring to FIG. 4, the circumferential distance S was set within the range of equal to or more than −20% and equal to or less than 20%. For comparison with Embodiment 1 (satisfying L/P=0.13 and D/P=0.19, and indicated by the thick solid line) and Embodiment 2 (satisfying L/P=0.13 and D/P=0.26, and indicated by the thin solid line), the analysis was conducted with Comparative Examples 3 and 4. Comparative Example 3 satisfies L/P=0.13 and D/P=0.31, and is indicated by the thick dashed and two-dotted line. Comparative Example 4 satisfies L/P=0.13 and D/P=0.36, and is indicated by the thin dashed and two-dotted line. The negative sign of the circumferential distance S indicates a circumferential distance starting from the leading edge 32c (the closest part to the combustor 2 side) of the first stage nozzle 32 toward the opposite side (on the leading edge 32c side) to the trailing edge 32d side of the first stage nozzle 32.

As can be apparently seen in FIG. 3, the smaller the axial distance L between the leading edge 32c of the first stage nozzle 32 and the transition piece rear end 222, the further the development of wake flows after the transition piece rear end 222 of the combustor 2 is suppressed. It is thus observed that the occurrence of edge tones along the leading edge 32c of the first stage nozzle can be suppressed. Furthermore, as in Embodiment 1 (thick solid line), Embodiment 2 (thin solid line), Embodiment 3 (thick dashed-dotted line), Embodiment 4 (thin dashed-dotted line), and Comparative Example 1 (thick broken line), it is observed that the edge tone pressure fluctuation level is desirably below the set tolerance with the circumferential distance S in the range of equal to or more than 5% and equal to or less than 15% of the circumferential pitch P, and particularly, the edge tone pressure fluctuation level is the lowest with the circumferential distance S set at 10%.

As can be apparently seen in FIG. 4, in Embodiment 1 (thick solid line), Embodiment 2 (thin solid line), Comparative Example 3 (thick dashed and two-dotted line), and Comparative Example 4 (thin dashed and two-dotted line), the aerodynamic efficiency of the first stage nozzles 32 is in the set tolerance range with the circumferential distance S in the range of equal to or more than about 2.5% of the circumferential pitch P. Furthermore, in Embodiment 1 (thick solid line) and Embodiment 2 (thin solid line), the aerodynamic efficiency of the first stage nozzles 32 is stable at high levels with the circumferential distance S in the range of equal to or more than about 5% and equal to or less than about 15% of the circumferential pitch P. In particular, it is observed that the aerodynamic efficiency is enhanced to the greatest degree with the circumferential distance S set at 10%. In addition, it is observed that the aerodynamic efficiency is further enhanced when the rate of the circumferential thickness D to the circumferential pitch is smaller than other cases, as in Embodiment 1 (thick solid line) and Embodiment 2 (thin solid line) satisfying D/P=0.19 and D/P=0.26, respectively.

These analysis results reveal that, as described above, by setting the circumferential distance S relative to the circumferential pitch P within the range of 0.05≦S/P≦0.15 and setting the axial distance L relative to the circumferential pitch P within the range of 0.00≦L/P≦0.13, the occurrence of edge tones can be suppressed to suppress the inner pressure fluctuations of the combustor, and the aerodynamic efficiency can be enhanced.

Furthermore, by setting the circumferential distance S relative to the circumferential pitch P to satisfy S/P=0.10, the occurrence of edge tones can be further suppressed to suppress the inner pressure fluctuations of the combustor, and the aerodynamic efficiency can be enhanced.

When the axial distance L relative to the circumferential pitch P is made to satisfy 0.00=L/P, the resultant configuration is that the leading edge 32c of the first stage nozzle 32 and the transition piece rear end 222 are placed closest to each other. With this configuration, because the development of wake flows after the transition piece rear end 222 of the combustor 2 is suppressed, the occurrence of edge tones can be suppressed to suppress the inner pressure fluctuations of the combustor. In such cases that a seal member is placed between the combustor 2 and the turbine 3, the axial distance L relative to the circumferential pitch P may fail to satisfy 0.00=L/P due to the structural constraints of the gas turbine. In such a case, in consideration of the constraints, the axial distance L is preferably set relative to the circumferential pitch P within the range of 0.08≦L/P≦0.13.

By setting the circumferential thickness D relative to the circumferential pitch P within the range of D/P≦0.26, the occurrence of edge tones can be further suppressed to suppress the inner pressure fluctuations of the combustor, and the aerodynamic efficiency can be enhanced. Making the circumferential thickness D relative to the circumferential pitch P satisfy D/P=0, i.e., D=0, can be achieved by forming the transition pieces 22 of the combustors 2 that are adjacent in the circumferential direction in a single ring shape, for example. If it is difficult to make a configuration that satisfies D/P=0, the circumferential thickness D is preferably set relative to the circumferential pitch P within the range of 0.18≦D/P≦0.26.

### INDUSTRIAL APPLICABILITY

As described above, the gas turbine according to the present invention is suitable, with an improved relative position of the combustor transition piece and the turbine first stage nozzle, for achieving both suppression of the inner pressure fluctuations of the combustor and enhancement in the aerodynamic efficiency.

1. A gas turbine that generates rotational power by supplying fuel to compressed air compressed by a compressor and burning the fuel in a combustor and supplying resultant combustion gas to a turbine, wherein
a circumferential distance S starting from a leading edge of a turbine first stage nozzle toward a trailing edge side of the first stage nozzle and ending at center of such combustors that are adjacent in a circumferential direction is set relative to a circumferential pitch P of such first stage nozzles within a range of 0.05≦S/P≦0.15, and an axial distance L between a leading edge of the first stage nozzle and a rear end of the combustor is set relative to the circumferential pitch P of the first stage nozzles within a range of 0.00≦L/P≦0.13.

2. The gas turbine according to claim 1, wherein the circumferential distance S is set relative to the circumferential pitch P to satisfy S/P=0.10.

3. The gas turbine according to claim 1, wherein the axial distance L is set relative to the circumferential pitch P within a range of 0.08≦L/P≦0.13.

4. The gas turbine according to claim 1, wherein a circumferential thickness D of a rear end of the combustors that are adjacent in the circumferential direction is set relative to the circumferential pitch P within a range of D/P≦0.26.
